(19) United States
(12) Patent Application Publication
(10) Pub. No.: US 2010/0122606 A1
(43) Pub. Date: May 20, 2010

(54) TIE ROD AND FORCE TRANSMITTING ASSEMBLY FOR A TIE ROD

(76) Inventor: Volker Stephan, Wittmund (DE)

Correspondence Address: BIRCH STEWART KOLASCH & BIRCH, PO BOX 747, FALLS CHURCH, VA, 22040-0747, US

(21) Appl. No.: 12/603,185

(22) Filed: Oct. 21, 2009

(30) Foreign Application Priority Data
Nov. 18, 2008 (DE) 10 2008 057 893.2

(51) Int. Cl. F16C 7/02; G05G 1/00; B23P 17/00

(52) U.S. Cl. 74/579 R; 29/419.1

(57) ABSTRACT

A force transmitting assembly comprises a composite fiber tie rod having a force transmitting element on the end thereof. The force transmitting element has at least a portion having a cross-section that tapers in a direction pointing away from the tie rod end. The load bearing fiber layer of the tie rod extends over and is wound about the tapered portion of the force transmitting element, thereby establishing a positive connection between the tie rod and the force transmitting element. The invention further relates to a method of manufacturing a force transmitting assembly comprising a composite fiber tie rod and a force transmitting element on an end thereof.

### FIELD OF THE INVENTION

The invention relates to a tie rod and a force transmitting assembly for a tie rod. The invention finds particular use in a composite fiber rod. According to the invention, the tie rod and a force transmitting element mutually engage in a positive fit in a region of the force transmitting element, the partial region tapering in a direction pointing away from the rod.

A tie rod as proposed by this invention may be used in the field of crane construction to anchor a lattice tower head. However, use of the invention is not so restricted and the invention is useful in any area where a tie rod type of structure is needed, and in numerous other areas where components are subjected to axial tensile forces and the forces have to be transmitted into a structural element comprising a composite fiber material.

The advantage of tie rods made from a composite fiber material over conventional tie rods made from steel is that they are able to absorb the same high tensile forces but have a lower intrinsic weight. Stated differently, higher tensile forces can be absorbed by a tie rod made from a composite fiber material which is of the same intrinsic weight as a steel rod.

### BACKGROUND OF THE INVENTION

Documents DE 10 2006 039 565 A1, DE 102 49 591 A1 and DE 10 2004 021 144 A1 disclose means for transmitting forces for composite fiber rods, whereby force transmitting elements are connected to the composite fiber rods by using adhesives and/or by a frictional fit in order to transmit force into the composite fiber rod. However, such force transmitting assemblies are not sufficiently satisfactory and can only withstand a limited amount of the force which has to be transmitted into the composite fiber rod. Accordingly, force transmitting assemblies of these types are not suitable for applications in which very high forces occur, such as crane construction.

The invention provides a force transmitting assembly that is suitable for a composite fiber tie rod, by means of which very high forces can also be transmitted to the tie rod. A tie rod according to the invention requires no maintenance, no adjustment and is easy to manufacture.

A tie rod according to the invention includes a force transmitting element on which the force transmitted to the tie rod acts. Such a force acts in a direction that is essentially parallel with the longitudinal axis of the tie rod. According to the invention, the force transmitting element includes a section or region that tapers in a direction pointing away from the end of the tie rod. By engaging with the tie rod in this region or section, a positive and secure fit is obtained between the force transmitting element and an end region of the tie rod surrounding the tapered portion. In other words, the end of the tapered region of the force transmitting element facing the tie rod has a bigger cross-section than the end of the tapered region facing away from the tie rod. The end region of the tie rod surrounds the tapered portion of the force transmitting element and is held thereto. Consequently, it is not possible to “pull out” the force transmitting element from the tie rod due to the tapered shape of the portion of the force transmitting element and the correspondingly tapered configuration of structural portions at the end of the tie rod. Due to the positive fit created between the force transmitting element and tie rod in this manner, very high forces acting on the force transmitting element can be transmitted to the tie rod.

The tie rod, in the region of the force transmitting element, has a hollow profile so that it completely encloses the force transmitting element circumferentially in the tapered region, and the force transmitting element extends out beyond the tie rod with this hollow profile so that the force to be transmitted to the tie rod acts on the force transmitting element externally to the tie rod. Accordingly, the force to be transmitted does not have to be directed via separate components into a region inside the hollow profile surrounding the tie rod. Also, the fact that the force transmitting element, which is formed as one piece, extends out from the hollow profile obviates the need for connecting points between force-transmitting components, which would otherwise constitute structural weak points and possibly tear out, for example. However, it is also within the scope of the invention for the force to be transmitted to the tie rod to act on the force transmitting element inside the hollow profile of the tie rod, in which case the force transmitting element need not necessarily extent out from the end of the tie rod. Likewise, the tapered region of the force transmitting element need not be completely surrounded by the tie rod, either circumferentially or in the axial direction, although it is preferable if the force transmitting element is completely “enclosed” by the tie rod in the tapered region at least in the circumferential direction so that the force transmitting element is positively connected to the tie rod in every radial direction.

According to the invention there may be provided a winding on the external circumference of the tie rod, at least in the region in which the tie rod “encloses” the force transmitting element or where the tie rod is disposed circumferentially around the force transmitting element. This external winding may be formed by providing a fiber composite layer in which the fibers extend preferably transversely to the longitudinal axis of the tie rod. By particular preference, the fibers of this winding extend orthogonally to the primary axis of the tie rod and circumferentially thereof in at least the tapered region of the force transmitting element. The purpose of this winding is to assist the positive fit between the force transmitting element and the tie rod. With such a winding or similar means in place it is, therefore, impossible to widen the tapered end of the tie rod or pull out the force transmitting element because the circumferential winding effectively prevents the tie rod end from widening by absorbing the forces acting in the circumferential direction.

In a device according to the invention both the tapered region of the force transmitting element and the tie rod have a rotationally symmetrical cross-section, and the axis of symmetry of the tapered region of the force transmitting element coincides with the axis of symmetry of the tie rod. This rotationally symmetrical design advantageously enables a device according to the invention to absorb torsional moments better than a tie rod with an asymmetrical cross-section. Another advantage of a round profile of the tie rod is that it prevents vibrations in the tie rod induced by wind forces.

According to the invention, the tie rod may sit directly against the force transmitting element, perhaps with a flat interface, thereby resulting in a direct physical contact between the tie rod and force transmitting element. It is of advantage to have a direct contact of the tie rod with the force transmitting element in the tapered region of the force transmitting element, without other intervening or interconnected elements, because the force acting on the force transmitting element can be transmitted directly into the tie rod without unnecessarily deflecting the force flow because it has to be directed via other interconnected elements. None the less, additional layers may be provided in or on the tie rod, for example coatings to protect against thermal or mechanical effects on the tie rod or electrically conducting coatings and electrically isolating coatings, but these are regarded as part of the tie rod and therefore not considered as separate or “interconnected” elements.

The tapered region of the force transmitting element may taper conically away from the tie rod. The taper of this region may extend essentially constantly across the longitudinal axis of the region. This advantageously causes the fibers in the tie rod to run in as straight a line as possible so that the force passes through the rod in a straight line, thereby improving the ability of the force transmitting assembly to support a load.

In a preferred embodiment, the cross-sectional gradient of the internal circumference of the tie rod changes abruptly in the axial direction in the partial region of the force transmitting element. By particular preference, an abrupt change in the cross-sectional gradient occurs in the region of the end of the partial region facing the tie rod. As a result of such an abrupt change, especially if the change in cross-sectional gradient is one where the internal or external wall of the tie rod changes from a tapering region into a region extending essentially parallel with the longitudinal axis of the tie rod, a clear region can be defined by such an abrupt change in cross-sectional gradient where the force is transmitted from the force transmitting element to the tie rod due to the positive connection.

It is also possible for the cylindrical core of the tie rod to bound or abut the end of the partial region facing the tie rod. This results in a seamless transition from the partial region of the force transmitting element to the core of the tie rod at the internal wall of the tie rod. It would also be conceivable to opt for a design in which the entire force transmitting element directly adjoins the core of the tie rod, in which case the tapering partial region is specifically disposed on the end of the force transmitting element facing the tie rod.

A tie rod according to the invention is preferably made from a wound fiber composite wherein a wound fiber composite layer absorbs the major part of the load or transmitted force. A variety of other wound fiber composite layers may also be included. For example, wound protective layers may be provided to protect against UV radiation or to prevent electrical contact between the force transmitting element and another fiber composite layer of the tie rod. The advantage of a wound fiber composite is that any profile of the tie rod can be manufactured using an inexpensive process, and large cross-sections and thick wall thicknesses can also be produced. A wound tie rod structure is of particular advantage if the taper of the force transmitting element is in the end region of the tie rod with the cross-sectional taper of the tie rod connected to it because the corresponding change in cross-section of the tie rod can be easily produced. The tapering end of the tie rod also chokes or contracts under load when the force transmitting element is acted upon by a pulling force, thus strengthening the positive fit. A wound tie rod normally has more than one, but only a few (i.e., 2-4), preferred directions in which the fibers of the fiber composite extend, and it is possible to obtain an exact reproducibility for wound tie rods on the basis of FEM calculations.

The force transmitting assembly according to the invention may also have a collar or similar element extending circumferentially around the force transmitting element, against which the circumferential winding at the tie rod end can be supported in the axial direction. This collar may be joined to the force transmitting element, for example by bonding or welding, or may incorporate a locating element which is able to locate on the force transmitting element in co-operating locating elements, such as a thread for example. This prevents the winding from “slipping” on the rod end in the direction of the end of the force transmitting element pointing away from the tie rod, thereby enabling a more reliable positive fit to be maintained between the force transmitting element and the tie rod.

According to the invention, the force transmitting element may be made from an iron-based material such as steel. The tie rod may be made from a carbon fiber composite material, in which case the carbon fiber composite material absorbs substantially all of the axially applied force which is transmitted via the force transmitting element to the tie rod. Accordingly, the layer of carbon fiber composite material constitutes the “supporting layer” of the tie rod. The tie rod may also contain other elements, such as a core extending coaxially with the longitudinal axis of the tie rod, around which the fiber composite layers of the tie rod are disposed and/or other layers to protect the tie rod, for example, against UV radiation or mechanical forces acting on the circumferential surface of the tie rod, electrically isolating layers for adjoining elements with different electronegativity or electrically conducting layers for arresting electrical energy due to a lightning strike. In particular, the tie rod or the force transmitting assembly may incorporate one or more of the following elements.
A layer or a ply comprising a copper-based material for arresting electrical energy, caused by a lightning strike, for example. Such a layer is preferably disposed on the external circumference of the tie rod and preferably lies directly on the external circumference of the carbon fiber composite layer of the tie rod.
A first ply or a first layer comprising a glass fiber composite material to protect against UV radiation, in which case this layer is preferably the outermost layer of the tie rod.
A second ply or a second layer comprising a glass fiber composite material for electrically isolating the force transmitting element from the carbon fiber composite layer of the tie rod, in which case this second layer is preferably disposed at the interface between the carbon fiber composite layer of the tie rod and the force transmitting element. This effectively prevents contact corrosion which might otherwise occur due to the differing electronegativity of the force transmitting element made from steel and the carbon fiber composite material.
A winding disposed on the outermost layer of the tie rod, to protect against mechanical effects on the circumferential surface of the tie rod. Such a winding may comprise a strand of a glass fiber composite material extending in a spiral shape in the longitudinal direction around at least the end regions of the tie rod on the circumferential surface thereof. This effectively prevents impacts with the circumferential surface of the tie rod which could otherwise damage the tie rod causing the layers to peel. This winding may also extend around the circumferential surface of the winding on the tie rod end, which ensures the positive fit between the force transmitting element and tie rod.

The invention further relates to a method of manufacturing the force transmitting assembly proposed by the invention for a tie rod.

The method of the invention, involves establishing a positive connection of the force transmitting element to the tie rod in a partial region of the force transmitting element which tapers in a direction pointing away from the tie rod.

The manufacturing method proposed by the invention may preferably incorporate one or more of the following steps.
The force transmitting element is fitted on one end of a core, which core may have an elongate cylindrical shape. A centering element may be used for this purpose, by means of which the force transmitting element can be fitted on the core in only one specific disposition or specific position or orientation. Such a centering element may be a rod or tube disposed concentrically in the core and extending out of it, on which the force transmitting element can be fitted by means of a central bore in the force transmitting element.
A tie rod may be formed around the core and around at least a part of the force transmitting element fitted on the core, for example by a winding process. In this respect, the tie rod must also be formed across at least a part of the tapering partial region of the force transmitting element in accordance with the invention so that the force transmitting element is already connected to the tie rod incorporating the core by wrapping or by winding. In this connection, the process of forming the tie rod around the core and around the force transmitting element may involve several individual steps, such as for example winding the carbon fiber composite layer constituting the main supporting layer of the tie rod, winding individual glass fiber composite layers to form protective layers or isolating layers and to form an electrically conductive layer made from copper, for example. It would also be conceivable to use other methods to form the fiber composite layers, for example pultrusion, braiding, knitting or manual wrapping of pre-impregnated fiber composite material.
The region in which the tie rod is disposed surrounding the force transmitting element, in other words the tapering region of the force transmitting element, may be circumferentially wound to secure the positive fit, in which case it is preferable to opt for a winding using a composite fiber material. If winding with a composite fiber material, the direction of the fibers in the wound layer should extend circumferentially if possible or at least be such that a reliable hold of the tie rod is obtained on the tapering partial region of the force transmitting element. This can be achieved by means of an FEM simulation for example, thereby enabling a sufficiently stable winding of the tie rod to be obtained even if using fibers which do not extend around the circumference.
After creating individual fiber composite layers, these can then be cured in a drying process, having applied a matrix to the wound material of each of the individual layers (unless pre-prepared “prepreg” was used). In order to speed up this process, curing may also take place at an increased temperature.
The wound material extending away from the tie rod beyond the tapering partial region of the force transmitting element can then be cut from the tie rod, for example by mechanical cutting, so that a circumferentially extending collar can then be fitted on the force transmitting element, which holds the circumferential winding of the tie rod end in position.
The circumferential surface of the tie rod can be protected against mechanical effects by, for example, a strand of glass fiber composite material wound in a spiral shape around the tie rod. If an object impacts the circumferential surface of the tie rod, it will initially make contact with the strand wound in a spiral shape around the tie rod so as to avoid other physical contact that might occur between the object and the actual circumferential surface of the tie rod.
The finished tie rod with the force transmitting assemblies at its ends can then be stretched under a test load. In a preferred embodiment of this invention the test load is 1800 kN, although it would also be conceivable to opt for a lower or higher test load depending on the design and dimensions of the tie rod in question.

The invention will be best understood from the following description of a preferred embodiment illustrated in the appended drawing. The invention may incorporate some or all the features disclosed here, either individually or in any practical combination.

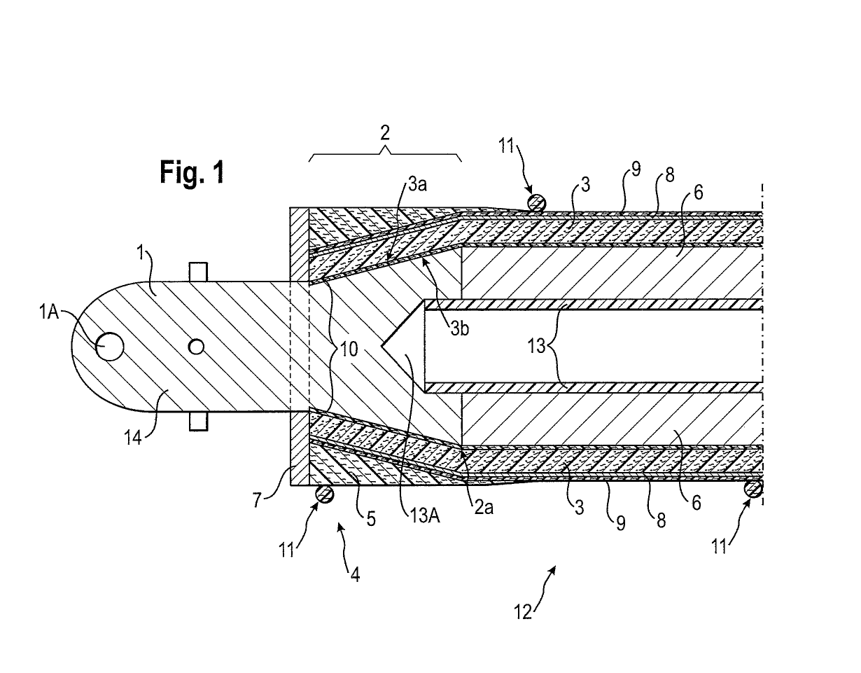

FIG. 1 is an axial sectional view through an end region of a tie rod comprising a force transmitting assembly in accordance with the invention.

A tie rod, generally designated by reference numeral 12, typically comprises a cylindrical core 6 that extends the length of the tie rod. A carbon fiber composite layer (CFC), which is denoted by reference number 3 in FIG. 1, is wrapped about core 6. In this preferred embodiment, a glass fiber composite layer 10 is disposed on the internal circumferential surface of the carbon fiber composite layer 3, adjacent the core 6. The purpose of layer 10 will be explained below. Disposed on the external circumference of the carbon fiber composite layer 3 is an electrically conducting layer 8 made from, i.e., copper, by means of which electrical energy that might be transmitted to the tie rod by a lightning stroke can be arrested. Disposed on the external circumferential surface of the electrically conducting layer 8 is another layer 9 made from a glass fiber or similar material, which protects the tie rod 12 against the effects of UV radiation. These layers 3, 8, 9 and 10 are formed on the external circumference of the elongate and cylindrical core 6, which extends the entire length of the tie rod 12. The fiber composite layers 3, 9 and 10 can be specifically produced using a winding technique such that these layers have only a few defined preferred directions in terms of the direction in which the fibers extend.

Disposed at the end 4 of the tie rod 12 is a force transmitting element 1, via which the tie rod is attached to another structural element and a force to be transmitted to the tie rod 12 is transmitted. To this end, a force absorbing means or connector in the form of an eye 1A is provided on the left-hand end of the force transmitting element 1. It is understood that this configuration is exemplary, and the connecting/force absorbing portion of element 1 can assume any practical form.

Towards the right-hand end of the force transmitting element 1, the force transmitting element has a portion comprising a frustoconical shape, the cross-section of which becomes wider in a right-to-left direction in partial region 2. As viewed from the tie rod 12, the partial region 2 tapers away from the end of the tie rod 12. The end 2a of the tapering partial region 2 facing the tie rod 12 constitutes the end of the force transmitting element 1 facing the tie rod 12, which lies flat against the core 6 in this preferred embodiment. At the end 2a, the partial region 2 of the force transmitting element 1 has a circumference that is substantially identical to the circumference of the core 6. The force transmitting element 1 is centered with respect to the tie rod 12 and core 6 by means of a coaxially extending plastic tube 13 disposed internally along the axis of the core 6. Tube 13, which may be solid in cross section or which may have a hollow configuration, extends out beyond the end of core 6. The force transmitting element 1 may have a recess 13A by which the element 1 can be fitted on the projecting end of the plastic tube 13. Tube 13 can be joined to the core 6 by a material join, for example by bonding. Tube 13 may be formed, for example, from a plastic material.

A winding of another fiber composite layer 5 is provided at least in the partial region 2 where the additional layers 8, 9 and 10 of tie rod 12 extend about the partial region of force transmitting element 1. The fibers in this fiber composite layer 5 also extend in the circumferential direction. In order to hold this winding 5 in position in the partial region 2, a circumferentially extending collar 7 may be additionally provided on the force transmitting element 1. Collar 7 may be bonded onto the force transmitting element 1 by a material join. As also illustrated in FIG. 1, a protective layer may also provided in the form of a glass fiber strand 11 extending in a spiral shape around the external circumference of the tie rod 12.

Since the carbon fiber composite material 3 has a different electronegativity from the iron-based material of the force transmitting element 1, an electrically isolating glass fiber composite material layer 10 is advantageously provided at the interface 3b between the carbon fiber composite material 3 and the force transmitting element 1 in order to prevent corrosion due to contact.

According to the invention, the force transmitting assembly is made by fitting the force transmitting element 1 on the end of the tie rod core 6 and aligning the two by means of the tube 13. Tube 13 may be bonded to the force transmitting element 1 and/or to the core 6. The tube 13 also serves as a means of determining the component length. Tube 13 also provides another advantage in conjunction with the core 6 in that at least slight pressure forces can be applied to the tie rod 12 in the radial as well as the axial direction.

The different plies or layers 3, 8, 9 and 10 of the tie rod 12 can be formed one after the other on the external circumference of the core 6 and at least on the external circumference in the partial region 2 of the force transmitting element 1 by a winding technique. Knobs may be provided on the circumference of the left-hand region of the force transmitting element 1 and used to rotate the core 6 and force transmitting element 1 as needed for the winding operation, although these are not illustrated in FIG. 1. Once the individual layers 3, 8, 9 and 10 have been applied, a circumferential winding 5 is applied to the end of the tie rod 12 in the partial region 2 in order to establish and maintain the positive fit between the tie rod 12 and force transmitting element 1. The entire assembly may then be cured, as necessary.

Once the individual fiber composite layers have been cured, any material of the tie rod 12 extending beyond the partial region 2 is mechanically cut and the collar 7 is pushed onto the force transmitting element 1 and bonded to it. The winding 5 can therefore be held in position on the partial region 2, supported against the collar 7. The collar 7 maintains the winding 5 in position about the tapered portion of the force transmitting element in partial region 2, and also protects the end of the tie rod assembly from impacts. Additional protection against impacts to the tie rod assembly is provided in the form of the glass fiber strand 11 wound in a spiral shape around the external circumference of the tie rod 12.

The portion of the tie rod assembly comprising layers 3, 8, 9 and 10 held tightly by would layer 5 to the surface of the frustoconical portion of the force transmitting element 1 in the partial region 2 secures the force transmitting element to the end of tie rod 6. This enables the force transmitting element to link the tie rod to another structure and to absorb significant forces without failure. In a particular embodiment of the invention, a finished tie rod 12 with the force transmitting assembly proposed by the invention is stretched under a test load of 1800 kN and the nominal load of such a tie rod 12 may be approximately 1300 kN. Such a tie rod 12 may have a length of 12 meters, a diameter of 120 mm and a wall thickness of 10 mm, for example.

1. A composite fiber tie rod comprising,
a core element and a load-bearing fiber layer surrounding said core element;
a force transmitting element having a first end adjacent an end of said core element of said tie rod and a cross-section which tapers in a direction pointing away from the tie rod end defining a tapered region of said force transmitting element;
said load bearing fiber layer extending beyond said core member and wound about said tapered region of the force transmitting element;
an external element surrounding said load bearing fiber layer and said tapered region of the force transmitting element for retaining said fiber layer in contact with the force transmitting element in the tapered region thereof;
said force transmitting element comprising a connection portion that extends beyond the fiber layer of the tie rod for connecting the tie rod to another structure.

2. A composite fiber tie rod as in claim 1, wherein said external element comprises a winding surrounding said fiber layer and said force transmitting element at least in the region where the fiber layer is wound about the tapered region of the force transmitting element.

3. A composite fiber tie rod as in claim 1, wherein the tapered region of the force transmitting element has a cross section that is rotationally symmetrical.

4. A composite fiber tie rod as in claim 1, wherein the end of the core element of the tie rod abuts the force transmitting element

5. A composite fiber tie rod as in claim 4. wherein the end of the core element of the tie rod and a surface of the force transmitting element in abutment with the end of the core element are both substantially flat.

6. A composite fiber tie rod as in claim 1, wherein the tapered region of the force transmitting element is conical in shape.

7. A tie rod assembly as in claim 1, wherein the shape of the fiber layer of the tie rod wound about the tapered portion of the force transmitting element conforms to the shape of the tapered region.

8. A composite fiber tie rod as in claim 1 to, said cylindrical core further comprising a central core element.

9. A composite fiber tie rod as in claim 8, wherein said central core element extends beyond the end of said core element.

10. A composite fiber tie rod as in claim 9, wherein said force transmitting element has a recess for receiving said central core element for positioning said force transmitting element with respect to the end of said core element.

11. A composite fiber tie rod as in claim 2, further comprising a collar extending circumferentially around the force transmitting element for restraining said winding in an axial direction.

12. A composite fiber tie rod as in claim 1, wherein the force transmitting element is comprised of an iron-based material and the load bearing fiber layer is comprised of a carbon fiber composite material.

13. A fiber composite tie rod as in claim 1, further comprising a layer comprising a copper-based material disposed on the external circumferential surface of the tie rod.

14. A fiber composite tie rod as in claim 1, further comprising a layer comprising a glass fiber material disposed between the force transmitting element and the fiber layer of tie rod.

15. A fiber composite tie rod as in claim 1, further comprising a layer comprising a glass fiber material disposed on the external circumferential surface of the tie rod.

16. A method for manufacturing a force transmitting assembly comprising:
providing a core for a load bearing element;
positioning a force transmitting element adjacent an end of the core, the load bearing element including a portion that is tapered in a direction extending away from said core;
winding a load bearing fiber material around the core and around at least the tapered portion of the force transmitting element; and
applying an external securing element at least in the region where the load bearing fiber material is wound about the tapered portion of the force transmitting element.

17. The method of claim 16, wherein said applying an external securing element comprises applying an additional winding over said load bearing fiber layer at least in the region where said fiber layer is wound about the tapered portion of said force transmitting element.

18. The method of claim 17, further comprising fitting a collar on the force transmitting element to retain said additional winding in an axial direction.
